(19) United States
(12) Patent Application Publication
(10) Pub. No.: US 2005/0128737 A1
(43) Pub. Date: Jun. 16, 2005

(54) Caplight

(76) Inventor: Francis Pare', Salem, NH (US)

Correspondence Address: Francis Pare', 121 Lawrence Road, Salem, NH, 03079, US

(21) Appl. No.: 10/977,372

(22) Filed: Oct. 29, 2004

Related U.S. Application Data
(60) Provisional application No. 60/528,029, filed on Dec. 9, 2003.

(51) Int. Cl. F21L 2/00

(52) U.S. Cl. 362/157

(57) ABSTRACT

A flashlight, consisting of a body, necassary for holding the appropriate size power source.located on each side of the light body is a retractable arm needed to securely fasten the light to the visor of any given baseball cap. these retractable arms are made to fold under the light for proper storage. With a tension spring at the elbow of the arm; this allows it to have tension. Each arm is to have a clip on each end and a clip under the body that would allow the light to slide on the visor of the cap; securing itself in three different areas along the whole length of the cap . . . for added strength and security. The light bulb housing would be connected to the body of the light by a ball-and-socket connection allowing the lighting to be directed in a variety of different angles. all powered by the necassary wiring inside the bulb housing to the power source. The power switch would be located on the top of the light for easy access.

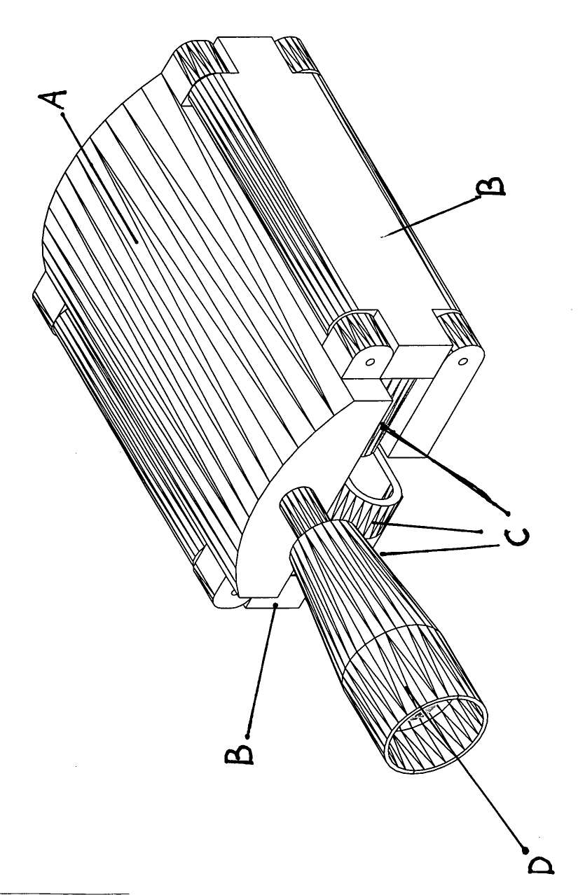

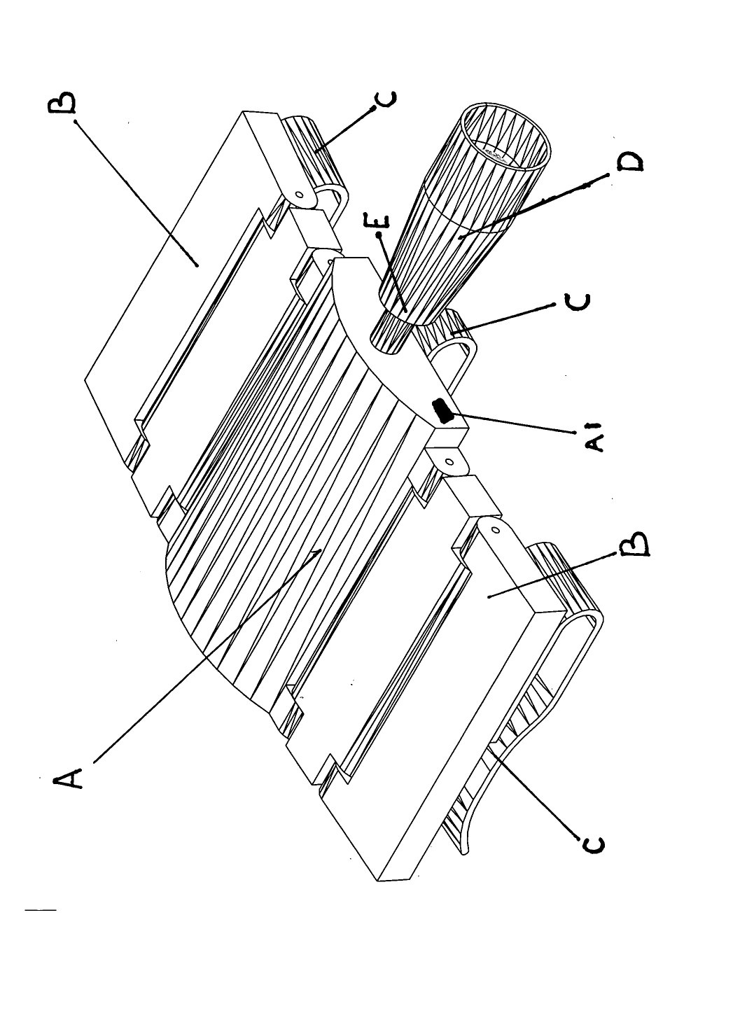

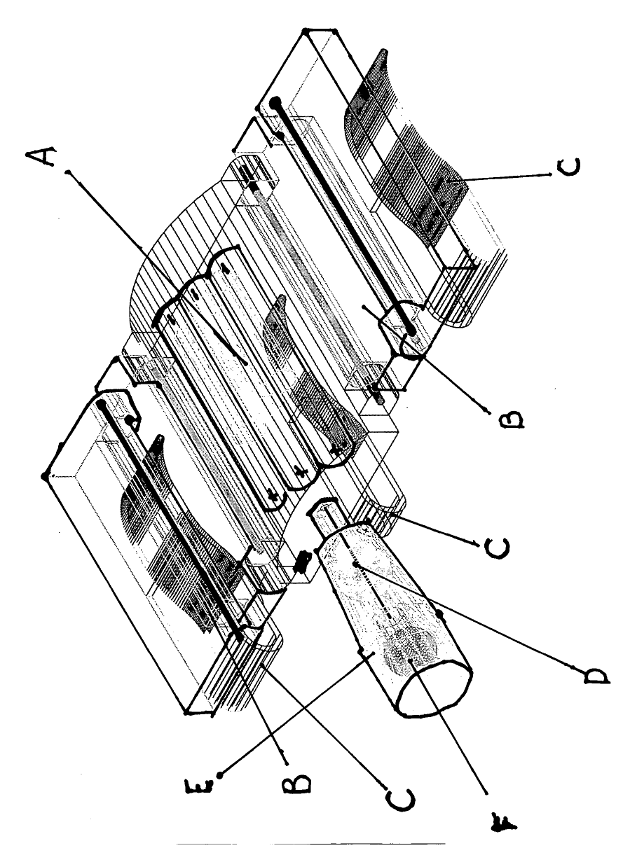

### CROSS REFERENCES

| Pat. # | Date | Inventor |
|---|---|---|
| 1)6,695,269 | Sep. 19, 2000 | Joseph Anscher |
| 2)D481,303 | Oct. 28, 2003 | Oscar Fell |
| | | Michael Squillante |
| 3)6,616,294 | Sep. 9, 2003 | David Henry |
| 4)6,604,837 | Aug. 12, 2003 | Robert Sandberg |
| 5)6,733,150 | May 11, 2004 | Edward Hanley |
| 6)6,721,962 | Apr. 20, 2004 | Michael Polaire |
| 7)6,719,437 | Apr. 13, 2004 | Todd Lary |
| | | Banning Lary |
| 8)6,648,489 | Nov. 18, 2003 | Ernest Fischer |
| 9)6,442,764 | Sep. 3, 2002 | Paul Badillo |
| 10)6,439,733 | Aug. 27, 2002 | Ernest Fischer |
| 11)5,608,919 | Mar. 11, 1997 | Richard Case |
| 12)5,567,039 | Oct. 22, 1996 | Kelly Sims |
| 13)5,463,538 | Oct. 31, 1995 | Robert Womack |
| 14)5,438,494 | Aug, 4, 1995 | Ben Harlen |
| 15)5,412,545 | May 2, 1995 | Brett Rising |
| 16)5,408,393 | Apr. 18, 1995 | Kenneth Becker |
| 17)5,386,592 | Feb. 7, 1995 | Mark Checkoroski |
| 18)5,268,826 | Dec. 7, 1993 | Roger Greene |
| 19)5,217,294 | Jun. 8, 1993 | John Liston |

### FIELD OF INVENTION

The caplight is a product that does not have one field of endeavor, but many.

The Caplight can be used in the field of automotive repair to home improvement, and in automotive emergency situations. The Caplight can also be used the field of fish and game and for children's amusement and safety. There are many fields which the Caplight can be useful.

### BRIEF SUMMARY OF INVENTION

The Caplight is a hands-free alternative to lighting in any situation where extra lighting would be necessary. It allows the user lighting that is very compact.

This would make the Caplight an excellent tool in the automotive repair industry because it would be small enough to fit in areas where auto technicians need to see to work. And, considering the amount of oil and debris; Most mechanics wear baseball caps to protect their hair.

The Caplight is also an excellent product to store in the vehicle in a case of emergency. Again, being very compact . . . It can be stored in a glove compartment or tool box. From changing a tire to checking your engine . . . You'll always have hands-free lighting that is directed to where your looking for safety and efficiency.

And when it comes to home repairs . . . The Caplight would be very effective in reducing the risk of injury due to the fact that you just slide it on the visor of your hat and you will have the needed light to do those odd jobs around the house where both hands are needed.

The Caplight can be very handy in your home due to it's size. It can be stored virtually anywhere. And the Caplight has so many other uses around the house from looking in closets or cupboards, to changing that fuse or lightbulb . . . Whereever you need light . . . The Caplight will be there. And with it's adjustable lens, you can adjust it to read.

The Caplight is also an excellent tool for the hunter or fisher and even camper. Lighting is always needed when your in the woods or by the lake camping or fishing. And you'll never have to hold a flashlight again. All without the need for those silly straps on your head or extra wires to get in the way. Just open your Caplight and slide it on the front of your existing hat and your ready to worm your hook or collect your firewood . . . With both hands.

The Caplight is also a great amusement for the children. They always like to run around at night with a flashlight and play. Now, the Caplight would allow them to do so. Without the need to hold a flashlight or wear a strap on their head. And the Caplight would be excellent for child safety because they can wear it at night when they are riding home on their bikes. It would give them the light they need to see the road and oncoming traffic would see it. All without the embarassment of wearing a strap on your head.

The Caplight would be a very versatile product that would replace the different hand held flashlights because of their inability to stay stationary and point in the line of vision. Different lights are good for different jobs . . . But the caplight is good for every job.

The Caplight is an excellent product because of it's size and because it easy to use. Just open the Caplight and slide it on your hat. And you'll always have the perfect view because it shines the light directly in front of your eyes . . . Where your looking.

### DRAWING DESCRIPTIONS

Drawing 1

Figure A: This is the main component of the Caplight. The battery source is stored here. (a-1) power switch.

Figure B: These are the ascending arms of the light. These are used for added support along the visor of the cap. Here they are in closed position for storage.

Figure C: These are the clips of the light. notice there are 3 seperate clips to give the light added grip to the hat and prevents sliding or turning. These 3 clips slide along the whole length of the visor.

Figure D: This is the bulb and housing of the light; Connected by a ball-n-socket for adjusting.

Drawing 2

Figure A: The light body for power source. (a-1) power switch.

Figure B: Retractable arms of light in open ready to use. There are tension pins for a tight fit.

Figure C: These are the clips which grip along the whole length of the visor.

Figure D: This is the bulb housing, it holds the appropriate size bulb.

Figure E: This is where the bulb housing connects to the body of the light. A ball-and-socket connects allows the light to be directed where needed.

### TECHNICAL ABSTRACT

Drawing 3

Figure A: The Caplight body. Constructed of a strong thermeplastic . . . Will hold the positive and negative terminals for the batteries. With the on/off power switch on top.

Figure B: The retractable arms which will be on a spring tension to keep them closed or to add support along cap visor.

Figure C: The clips of the light that are needed to hold on to the visor of the cap,

Figure D: The Ball-and-socket connection from the body of the light to the bulb housing. Inside is the wire needed to run current to the bulb.

Figure E: The housing for the lightbulb. Also made of thermoplastic.

Figure F: The light source of the Caplight. Consisting the bulb and lens.

I. What I claim as my invention is a light, durable flashlight that would allow hands-free use without the need for straps. A light that is exclusively designed for the use with a baseball cap and is engineered to stay stationary on the user's hat with the help of two retracting arms and three tight clips; Gripping the entire length of the visor.

II. I also claim that the Caplight, with it's adjustable lens, will allow the user to direct the light to it's needed position without the need for uncomfortable or tiresome positions. And the Caplight would be out of the user's way and view of vision . . . But yet, shining right in front of him.

III. I claim the Caplight will be made of a strong, durable, inexpensive thermoplastic that will be affordable and longlasting. With it's components and power source easily obtainable in the common market. And it will be compact enough to store just about anywhere in cases of emergency or where the need for two hands are needed for safety.
